(19) United States
(12) Patent Application Publication
(10) Pub. No.: US 2009/0175445 A1
(43) Pub. Date: Jul. 9, 2009

(54) Electronic Device, Home Network System and Method for Protecting Unauthorized Distribution of Digital Contents

(76) Inventors: Dong Ryeol SHIN, Gunpo-si (KR); Kee Hyun CHOI, Suwon-si (KR)

Correspondence Address: LEXYOUME IP GROUP, LLC, 5180 PARKSTONE DRIVE, SUITE 175, CHANTILLY, VA, 20151, US

(21) Appl. No.: 12/021,044

(22) Filed: Jan. 28, 2008

(30) Foreign Application Priority Data
Jan. 3, 2008 (KR) 10-2008-0000772

(51) Int. Cl. H04L 9/00

(52) U.S. Cl. 380/201

(57) ABSTRACT

The present invention relates to an electronic device, a home network system and a method for protecting unauthorized distribution of digital contents. The electronic device for protecting the unauthorized distribution of the digital contents includes an encryption key generator generating an encryption key; a contents player playing first digital contents; a contents regenerator generating second digital contents by converting the first digital contents played by the contents player into a predetermined data format; and a controller controlling the contents regenerator to encrypt the second digital contents by the use of the encryption key generated by the encryption key generator at the time when the contents regenerator generates the second digital contents.

### BACKGROUND OF THE INVENTION

1. Field of the Invention

The present invention relates to an electronic device, a home network system and a method for protecting unauthorized distribution of digital contents; and, more particularly, to an electronic device, a home network system and a method for protecting unauthorized distribution of digital contents capable of playing digital contents—the digital contents are generated by another electric device at the time when another electric device plays original digital contents and are encrypted by the use of the encryption key which is previously assigned another electric device—only in case that the electric device possesses the encryption key although the digital contents are distributed.

2. Background of the Related Art

Digital contents substantially include sound sources and images, audio files and video files, and other digital copyrighted works. The digital contents have been actually shared over P2P or Internet without a copyright holder's permission and such unauthorized distribution have caused a large financial damage to the copyright holder of the digital contents.

The reason not to intercept the illegal sharing of the digital contents is that files can be freely and easily copied. That is, since the digital contents can infinitely copied by the use of a computer, it is substantially difficult to intercept the illegal sharing of the digital contents. Accordingly, in recent years, there has been proposed a technology capable of playing the digital contents only in case that an electronic device possessing a digital contents' own encryption key by encrypting the digital contents by the use of the corresponding encryption key, whereby it is impossible to play the copied digital contents despite distributing the copied digital contents after the illegal copying of the digital contents.

However, the above-mentioned unauthorized playing protection technology using the encryption key is incapable of intercepting another type of copy of the sound sources and the video files, that is, an analog copy. That is, an analog format which is generated at the time of play the digital contents can be copied to a new format of digital contents by a specific software in a state where the digital contents are played in the computer through an authorized encryption key and since the copied digital contents have not yet encrypted, the copied digital contents can be played in other electronic devices.

### SUMMARY OF THE INVENTION

### Technical Problem

It is, therefore, an object of the present invention to provide an electronic device, a home network system and a method for protecting unauthorized distribution of digital contents capable of playing the digital contents only in case that another electronic device possesses an encryption key, although newly generated digital contents are encrypted by the encryption key, when other types of digital contents are generated in the process of reproducing the digital contents at the electronic device.

It is another object of the present invention to provide an electronic device, a home network system and a method for protecting unauthorized distribution of digital contents which allow a user having an authorized right for the digital contents to playing the digital contents through various electronic devices by registering encryption keys of electronic devices owned by the user having the authorized right for the digital contents in the home network server and by allowing the digital contents to be played in the electronic devices registered in the home network server in case that the digital contents are played by the user.

### Technical Solution

In order to achieve the above-mentioned objects, in accordance with a first aspect of the present invention, there is provided an electronic device for protecting unauthorized distribution of digital contents including an encryption key generator generating an encryption key; a contents player playing first digital contents; a contents regenerator generating second digital contents by converting the first digital contents played by the contents player into a predetermined data format; and a controller controlling the contents regenerator to encrypt the second digital contents by the use of the encryption key generated by the encryption key generator at the time when the contents regenerator generates the second digital contents.

Herein, the encryption key generator may include an RFID (Radio Frequency IDentification) tag in which the encryption key is stored and an RFID reader extracting the encryption key by reading the RFID tag.

The contents player may include a graphic adapter for playing video contents among the first digital contents, a sound card for playing audio contents among the first digital contents, and a multimedia codec for reproducing the first digital contents into an analog signal by decoding the first digital contents in conjunction with the graphic adapter and the sound card.

The controller may control the multimedia codec so as to convert the analog signal reproduced by the contents player into a digital signal and may control the contents regenerator to generate the second digital contents by compressing the digital signal in the predetermined data format, the digital signal being compressed with being encrypted by the encryption key, at the time of generating the second digital contents.

Herein, the first digital contents are distributed with being recorded in recording media and the electronic device may further include a contents reader reading the first digital contents from the recoding media in which the first digital contents are recorded.

Meanwhile, in order to achieve the above-mentioned objects, in accordance with a second aspect of the present invention, there is provided a home network system for protecting unauthorized distribution of digital contents including a first electronic device having a first encryption key; a second electronic device having a second encryption key; and a home network server in which the first encryption key and the second encryption key are registered, wherein the first electronic device plays first digital contents, generates second digital contents by converting the first digital contents into a predetermined data format and generates the second digital contents encrypted by the use of the first encryption key, wherein the second electronic device transmits information about the second digital contents and the second encryption key to the home network server at the time of playing the second digital contents, wherein the home network server performs the authentication of the second electronic device by the use of the second encryption key transmitted from the second electronic device and transmits the first encryption key to the second electronic device on the basis of the information about the second digital contents transmitted from the second electronic device, and wherein the second electronic device plays the second digital contents encrypted by the use of the first encryption key transmitted from the home network server.

Herein, the first electronic device may include a first RFID tag in which the first encryption key is stored and a first RFID reader extracting the first encryption key by reading the first RFID tag, and the second electronic device may include a second RFID tag in which the second encryption key is stored and a second RFID reader extracting the second encryption key by reading the second RFID tag.

The first electronic device may include a contents reader reading the first digital contents from recording media in which the first digital contents are recorded; a contents player playing the first digital contents read by the contents reader; a contents regenerator regenerating the second digital contents by converting the first digital contents played by the contents player into the predetermined data format; and a controller controlling the contents regenerator so that the second digital contents are encrypted by the user of the first encryption key at the time when the first contents regenerator generates the second digital contents.

Herein, the contents player may include a graphic adapter for playing video contents among the first digital contents, a sound card for playing audio contents among the first digital contents, and a multimedia codec for reproducing the first digital contents into an analog signal by decoding the first digital contents in conjunction with the graphic adapter and the sound card.

The controller may control the multimedia codec so as to convert the analog signal reproduced by the contents player into a digital signal and may control the contents regenerator to generate the second digital contents by compressing the digital signal in the predetermined data format, the digital signal being compressed with being encrypted by the encryption key, at the time of generating the second digital contents.

Meanwhile, in order to achieve the above-mentioned objects, in accordance with the third aspect of the present invention, there is a provided a method for protecting unauthorized distribution of digital contents including: generating a first encryption key; playing first digital contents; and generating second digital contents by converting the played first digital contents into a predetermined data format, the second digital contents being encrypted by the use of the first encryption key.

Herein, wherein the step of generating the first encryption key may include: preparing an RFID tag in which the first encryption key is stored in a first electronic device in which the first digital contents are played; and extracting the first encryption key by reading the RFID tag.

The step of playing the first digital contents may include playing the digital contents in an analog signal by decoding the first digital contents, and the step of generating the second digital contents may includes converting the analog signal into a digital signal and generating the second digital contents by compressing the digital signal in the predetermined data format, the digital signal being compressed with being encrypted by the first encryption key.

The method for protecting the unauthorized distribution of the digital contents may further include the steps of: registering the first encryption key and a second encryption key assigned to a second electronic device in a home network server; transmitting information about the second digital contents and the second encryption key from the second electronic device to the home network server at the time when the second electronic device reproduces the second digital contents; authorizing the second electronic device by the user of the second encryption key transmitted from the second electronic device by the home network server; transmitting the first encryption key from the home network server to the second electronic device on the basis of the information about the second digital contents, which is transmitted from the second electronic device in case that the authorization is completed by the second encryption key transmitted from the second electronic device; and playing the second digital contents encrypted by the use of the first encryption key transmitted from the home network server by the second electronic device.

### EFFECT OF THE INVENTION

According to the above-mentioned configuration, it is possible to play digital contents only in case that another electronic device possesses an encryption key, although newly generated digital contents are encrypted by the encryption key, when other types of digital contents are generated in the process of playing the digital contents at the electronic device. It is possible to protect unauthorized distribution of the digital contents by substantially intercepting an effectiveness of the unauthorized distribution of the digital contents generated secondarily.

A user having an authorized right for the digital contents can play the digital contents through various electronic devices by registering encryption keys of electronic devices owned by the user having the authorized right for the encrypted digital contents which the user has generated secondarily in the home network server and play the digital contents to be played in the electronic devices registered in the home network server in case that the digital contents are played by the user.

### BRIEF DESCRIPTION OF THE DRAWINGS

FIG. 1 is a diagram showing a configuration of an electronic device in accordance with the present invention;

FIG. 2 is a diagram showing a configuration in which the electronic device is realized in a computer in accordance with the present invention;

FIG. 3 is a diagram illustrating a method of generating second digital contents according to the electronic device in accordance with the present invention;

FIG. 4 is a diagram showing a configuration of a home network system in accordance with the present invention;

FIG. 5 is a diagram illustrating a process of generating the second digital contents in a second electronic device through the home network system in accordance with the present invention; and

FIG. 6 is a diagram illustrating a configuration in which the electronic device downloads first digital contents from a server in accordance with the present invention.

### DETAILED DESCRIPTION OF THE INVENTION

Hereinafter, preferred embodiments of the present invention will be described in more detail with reference to the accompanying drawings.

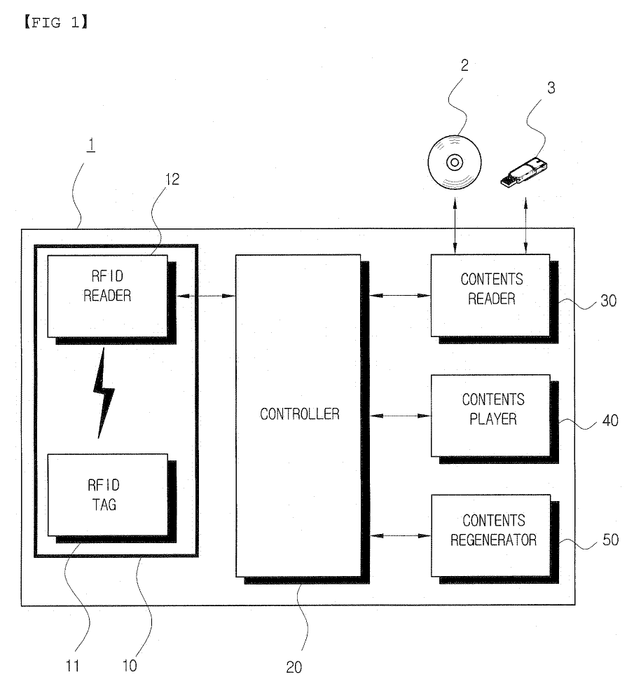

FIG. 1 is a diagram showing a configuration of an electronic device 1 for protecting unauthorized distribution of digital contents in accordance with the present invention. As shown in FIG. 1, the electronic device 1 in accordance with the present invention includes an encryption key generator 10, a contents reader 30, a contents player 40, a contents regenerator 50 and a controller 20.

The encryption key generator 10 generates an encryption key uniquely assigned to the electronic device 1 in accordance with the present invention. Herein, the encryption key generator 10 in accordance with the present invention may include an RFID tag 11 in which the encryption key is recorded and an RFID reader 12 extracting the encryption key by reading the RFID tag 11. Herein, the RFID tag 11 may be disposed in the electronic device 1 with the encryption key stored in the RFID tag 11 so as to store the unique encryption key assigned to the electronic device 1 in accordance with the present invention.

The contents reader 30 reads the digital contents from recording media 2 and 3 in which the digital contents such as audio contents and/or video contents are recorded. Herein, the recording media 2 and 3 may be prepared in various forms in which the digital contents are recorded, for example, in forms such as an optical disk 2 such as a CD (Compact Disk) or a DVD (Digital Versatile Disk) or a memory stick 3 such as a USB (Universal Serial Bus). Hereinafter, the digital contents played by the electronic device 1 in accordance with the present invention which is recorded in the recording media 2 and 3 will be described by defining the digital contents as first digital contents.

The contents player 40 plays the first digital contents read by the contents reader 30. Herein, the first digital contents which is played by the contents player 40 is converted into an analog signal for playing.

The contents regenerator 50 converts the first digital contents played by the contents player 40 according to a controller 20's control into a predetermined data format to generate second digital contents.

Herein, the controller 20 controls the contents regenerator 50 so that the second digital contents can be encrypted by the encryption key generated by the encryption generator 10, that is, extracted from the RFID tag 11 by being read by the RFID reader 12 at the time when the contents regenerator 50 generates the second digital contents.

According to the above-mentioned configuration, the second digital can be played only through the encryption key by encrypting the second digital contents by the use of the encryption key at the time of generating the second digital contents in the process of playing the first digital contents through the electronic device 1 although the second digital contents are distributed. Accordingly, the play of the second digital contents can be intercepted although the second digital contents generated secondarily are distributed by allowing the digital contents to be played only by the encryption key at the time of playing the second digital contents generated secondarily in the process of playing the first digital contents, thereby achieving the same effect as the interception of the distribution of the second digital contents.

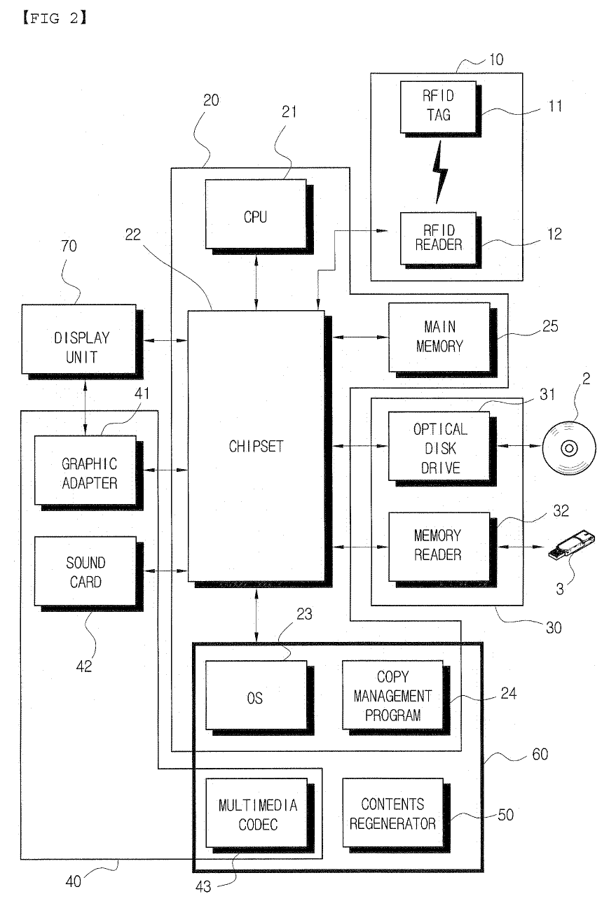

Hereinafter, an exemplary embodiment that the electronic device 1 in accordance with the present invention is a computer will be described in more detail with reference to FIG. 2.

First, as described above, the contents reader 30 may include an optical disk drive 31 such as a CD-ROM drive or a DVD-ROM drive for reading the first digital contents from the recording media 2 and 3 such as an optical disk 2 or a memory stick 3, and a memory reader 32.

The contents player 40 may include a graphic adapter 41, a sound card 42 and a multimedia codec 43 for playing the audio contents or the video contents. The graphic adapter 41 is used for playing the video contents among the first digital contents and the sound card 42 is used for reproducing the audio contents among the second digital contents.

The multimedia codec 43 reproduces the first digital contents into an analog signal by decoding the encrypted first digital contents which is encrypted as a predetermined format in conjunction with the graphic card 41 and/or the sound card 42. Herein, the multimedia codec 43 may include a software configuration for reproducing the first digital contents, for example, a driver in conjunction with the graphic adapter 41 and the sound card 42, audio and video codec programs, and application software for reproducing the audio files or the video files. The multimedia codec 43 may be stored in a hard disk drive 60 with being installed in the computer which is the electronic device 1.

Herein, the multimedia codec 43 may be prepared in a format distributed by a contents provider which provides the first digital contents in accordance with the present invention. The multimedia codec 43 can perform an encoding function and a decoding function by the use of the encryption key extracted from the RFID tag 11. The encoding function and the decoding function are librarized, whereby the encryption key of the RFID tag 11 is not used according to a request of the application software, but the library of the multimedia codec 43 itself uses the encryption key of the RFID tag 11 at the time of using the multimedia codec 43 in the application software for reproducing the audio files or the video files. Therefore, it is possible to disable the first digital contents to be reproduced in the electronic device 1 in which the RFID tag 11 or the RFID reader 12 is not installed by allowing the multimedia codec 43 to operate only by the encryption key stored in the RFID tag 11 even at the time of reproducing the first digital contents. That is, it is possible to achieve an effect of performing an authorization function at the time of the first digital contents by the use of the multimedia codec 43.

Meanwhile, the controller 20 controls functions of the above-mentioned contents reader 30, the contents player 40 and the contents regenerator 50, and operates the entirety of the computer which is the electronic device 1 in accordance with the present invention. Herein, as shown in FIG. 2, the controller 20 may include a CPU (Central Processing Unit) 21, a chipset 22, a main memory 25, an operating system 23 and a copy management program 24.

The main memory 25 operates as a main memory unit of the electronic device 1 and is prepared in the form of a RAM (Random Access Memory). Data or programs required to operating the operating system 23 or other application programs are temporarily stored in the main memory 25. The chipset 22 relays data exchange between the CPU 21 and other constituent members.

The copy management program 24 controls the contents regenerator 50 so that the second digital contents can be encrypted by the encryption key at the time when the second digital contents are generated by the contents regenerator 50 in the process of playing the first digital contents. Herein, the copy management program 24 may be prepared in the form of the application software operating under the operating system 23 and may be prepared in the form of a RAM resident program which resides in the RAM which is the main memory 25 so as to engage in the regeneration of the second digital contents by the contents regenerator 50.

Herein, the copy management program 24 controls the multimedia codec 43 so that the first digital contents of the analog signal form which are played by the content player 40 are converted into a digital signal. The copy management program 24 controls the contents regenerator 50 so that the second digital contents are compressed with encrypted by the encryption key the at the time when the contents regenerator 50 generates the second digital contents by compressing the digital signal converted by the multimedia codec 43 in a predetermined data format. Therefore, it is possible to prevent an error from occurring in the encryption key due to signal loss in the process of converting the analog signal into the digital signal at the time of assigning the encryption key in the process of converting the analog signal into the digital signal.

Meanwhile, the contents regenerator 50 in accordance with the present invention may be prepared in the form of the application program operating under the operating system 23 and as shown in FIG. 2, the contents regenerator 50 may be installed in the computer and may be stored in the hard disk drive 60.

Herein, undescribed reference numeral 70 of FIG. 2 represents a display unit 70 on which a video signal from the graphic adapter 41 is displayed in an image form.

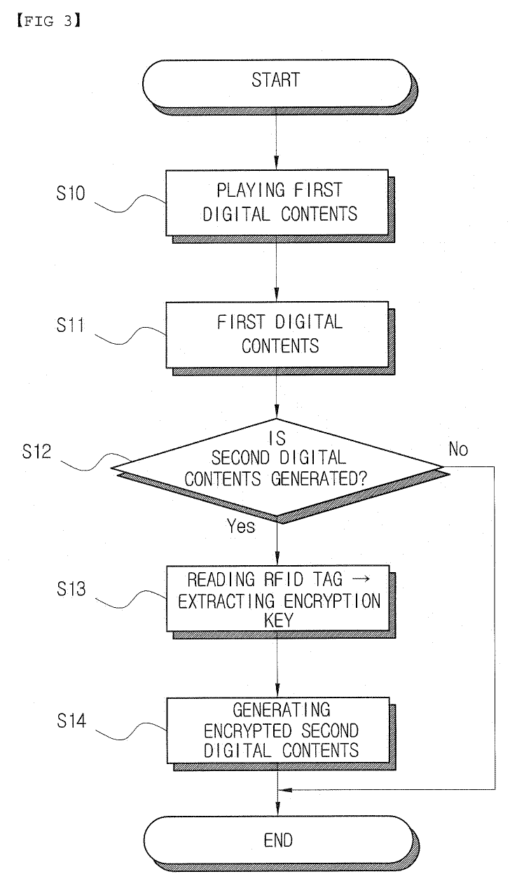

Hereinafter, a process in which the electronic device 1 in accordance with the present invention generates the second digital contents encrypted to protect the unauthorized distribution of the digital contents will be described with reference to FIG. 3.

First, the contents reader 30 reads the first digital contents from the recording media 2 and 3 in which the first digital contents are recorded (S10). After then, the first digital contents are reproduced by the contents player 40 (S11). Herein, the first digital contents played by the contents player 40 have the analog signal form as described above.

When the user executes the contents regenerator 50 so as to generate the second digital contents in a state where the first digital contents are played through the above-mentioned process (S12), the copy management program 24 of the controller 20 controls the RFID reader 12 to extract the encryption key by reading the RFID tag 11 (S13). The copy management program 24 controls the contents regenerator 50 so as to generating the second digital contents encrypted by the encryption key (S14).

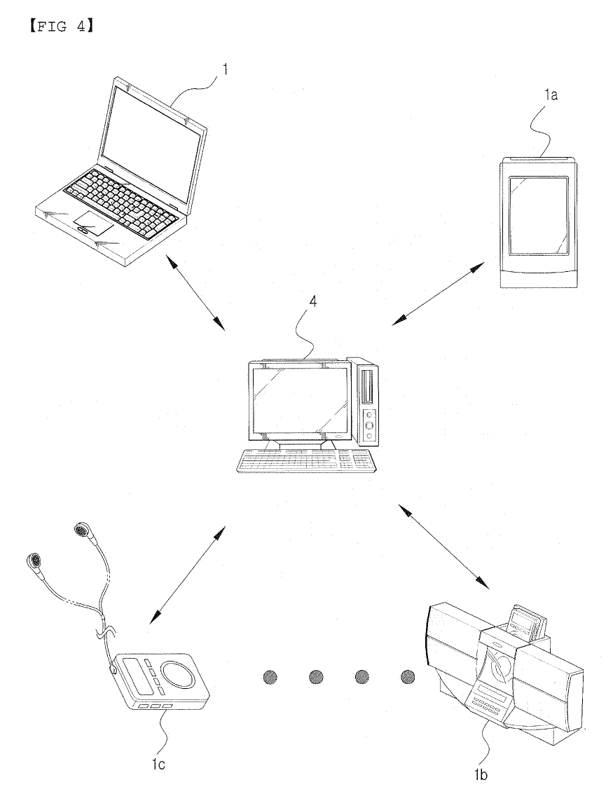

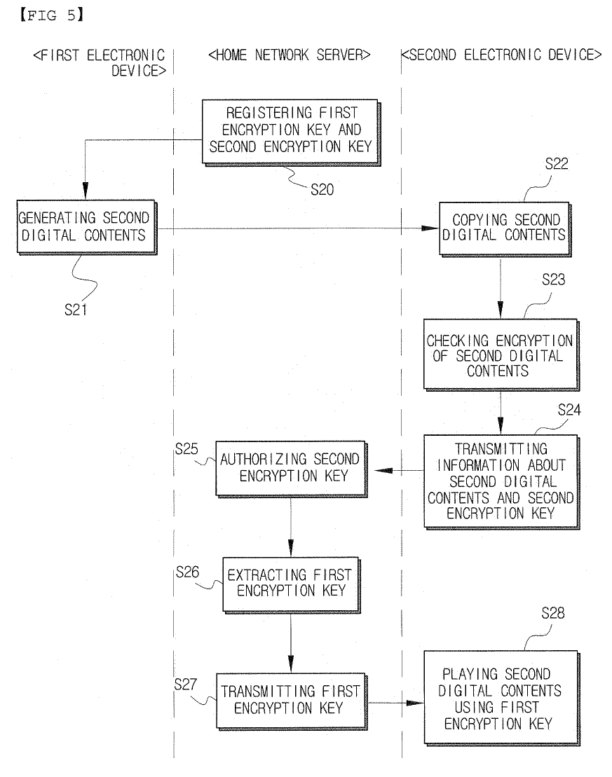

Hereinafter, the home network system in accordance with the present invention will be described in detail with reference to FIGS. 4 and 5. Herein, to describe the home network system in accordance with the present invention, the electronic device 1 generating the second digital contents is defined as a first electronic device 1 and other electronic device 1a, 1b and 1c generating the second digital contents generated by the first electronic device 1 is defined as second electronic devices 1a, 1b and 1c, as described above.

As shown in FIG. 4, the home network system in accordance with the present invention includes the first electronic device 1, at least one second electronic devices 1a, 1b and 1c, and a home network server 4.

The first electronic device 1 and the second electronic devices 1a, 1b and 1c have their own encryption keys. As described above, the first electronic device 1 extracts the encryption key through the RFID tag 11 and the RFID reader 12, and the second electronic devices 1a, 1b and 1c also extract the encryption keys in correspondence with the configuration of the first electronic device 1. Hereinafter, the encryption key of the first electronic device 1 is defined as a first encryption key, and the encryption keys of the second electronic devices 1a, 1b and 1c are defined as second encryption keys for description.

The first encryption key of the first electronic device 1, and the second encryption keys of the second electronic devices 1a, 1b and 1c are registered in the home network server 4 (S20). The home network server 4, the first electronic device 1, and the second electronic devices 1a, 1b and 1c constitute one home network.

Meanwhile, as described above, the second digital contents encrypted by the first encryption key are generated in the process of reading and playing the first digital contents recorded in the recording media 2 and 3 by the use of the first electronic device 1 (S21). The user copies the second digital contents stored in the first electronic device 1 to the second electronic devices 1a, 1b and 1c when the user want to play the second digital contents by the use of the second electronic devices 1a, 1b and 1c (S22).

Herein, the second electronic devices 1a, 1b and 1c check whether or not the second digital contents are encrypted at the time when the second electronic devices 1a, 1b and 1c play the second digital contents (S23), and transmits information about the second digital contents and the second encryption keys to the home network server 4 in case that the second digital contents are encrypted (S24).

The home network server 4 authorizes the second electronic devices 1a, 1b and 1c with the second encryption keys transmitted from the second electronic devices 1a, 1b and 1c by the use of the previously registered encryption keys of the first electronic device 1, and the second electronic devices 1a, 1b and 1c (S25). The home network server 4 extracts the first encryption key among encryption keys registered on the basis of the information about the second digital contents, which are transmitted from the second electronic devices 1a, 1b and 1c (S26) to transmit the extracted first encryption key to the second electronic devices 1a, 1b and 1c (S27) in case that the second electronic devices 1a, 1b and 1c are authorized. Herein, the information about the second digital contents may include various forms of information matching the first encryption key such as information about the first encryption key or information about the first electronic device 1.

The second electronic devices 1a, 1b and 1c receiving the first encryption key from the home network server 4 play the encrypted second digital contents by the user of the first encryption key (S28).

According to the above-mentioned configuration and method, in the home network system in accordance with the present invention, the user having the authorized right can play the digital contents through the various electronic devices 1, 1a, 1b and 1c by registering the first encryption key of the first electronic device 1 and the second encryption keys of the second electronic devices 1a, 1b and 1c which the user having the authorized right to the first digital contents possesses to play the encrypted second digital contents which the user generates secondarily.

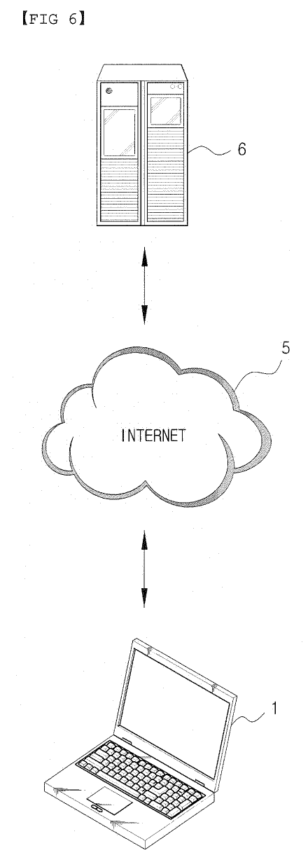

Meanwhile, FIG. 6 is a diagram illustrating a configuration in which the electronic device 1 downloads the first digital contents through Internet 5. That is, the electronic device 1 in accordance with the present invention may also play the first digital contents by downloading the first digital contents from a server 6 operated by the corresponding contents provider in addition to the method of the first digital contents by reading the first digital contents from the recording media 2 and 3.

At this time, the electronic device 1 transmits the encryption key recorded in the RFID tag 11 to the server 6 through the Internet 5 and the server 6 encrypts the first digital contents by the use of the encryption key of the electronic device 1 to download the encrypted first digital contents to the electronic device 1. Accordingly, it is possible to disable other electronic devices which do not posses the encryption key to play the first digital contents by playing the first digital contents downloaded by being encrypted by the electronic device 1's own encryption key by the use of the encryption key recorded in the RFID tag 11.

Although preferred embodiments of the present invention have been described in detail, the appended claims of the present invention is not limited to the preferred embodiment of the present invention and it will be apparent to those skilled in the art that various changes and modifications may be made without departing from the scope of the present invention as defined in the appended claims.

What is claimed is:

1. An electronic device for protecting unauthorized distribution of digital contents, comprising:
an encryption key generator generating an encryption key;
a contents player playing first digital contents;
a contents regenerator generating second digital contents by converting the first digital contents played by the contents player into a predetermined data format; and
a controller controlling the contents regenerator to encrypt the second digital contents by the use of the encryption key generated by the encryption key generator at the time when the contents regenerator generates the second digital contents.

2. The electronic device according to claim 1, wherein the encryption key generator includes:
an RFID (Radio Frequency Identification) tag in which the encryption key is stored; and
an RFID reader extracting the encryption key by reading the RFID tag.

3. The electronic device according to claim 2, wherein the contents player includes:
a graphic adapter for playing video contents among the first digital contents;
a sound card for playing audio contents among the first digital contents; and
a multimedia codec for reproducing the first digital contents into an analog signal by decoding the first digital contents in conjunction with the graphic adapter and the sound card.

4. The electronic device according to claim 3, wherein at the time of generating the second digital contents, the controller controls the multimedia codec so as to convert the analog signal reproduced by the contents player into a digital signal and controls the contents regenerator to generate the second digital contents by compressing the digital signal in the predetermined data format, the digital signal being compressed with being encrypted by the encryption key.

5. The electronic device according to claim 1, wherein the first digital contents are distributed with being recorded in recording media;
further comprising a contents reader reading the first digital contents from the recoding media in which the first digital contents are recorded.

6. The electronic device according to claim 2, wherein the first digital contents are distributed with being recorded in recording media;
further comprising a contents reader reading the first digital contents from the recoding media in which the first digital contents are recorded.

7. The electronic device according to claim 3, wherein the first digital contents are distributed with being recorded in recording media;
further comprising a contents reader reading the first digital contents from the recoding media in which the first digital contents are recorded.

8. The electronic device according to claim 4, wherein the first digital contents are distributed with being recorded in recording media;
further comprising a contents reader reading the first digital contents from the recoding media in which the first digital contents are recorded.

9. A home network system for protecting unauthorized distribution of digital contents, comprising:
a first electronic device having a first encryption key;
a second electronic device having a second encryption key; and
a home network server in which the first encryption key and the second encryption key are registered,
wherein the first electronic device plays first digital contents, generates second digital contents by converting the first digital contents into a predetermined data format and generates the second digital contents encrypted by the use of the first encryption key,
wherein the second electronic device transmits information about the second digital contents and the second encryption key to the home network server at the time of playing the second digital contents,
wherein the home network server performs the authentication of the second electronic device by the use of the second encryption key transmitted from the second electronic device and transmits the first encryption key to the second electronic device on the basis of the information about the second digital contents transmitted from the second electronic device, and
wherein the second electronic device plays the second digital contents encrypted by the use of the first encryption key transmitted from the home network server.

10. The home network system according to claim 9, wherein the first electronic device includes a first RFID tag in which the first encryption key is stored and a first RFID reader extracting the first encryption key by reading the first RFID tag, and
wherein the second electronic device includes a second RFID tag in which the second encryption key is stored and a second RFID reader extracting the second encryption key by reading the second RFID tag.

11. The home network system according to claim 10, wherein the first electronic device includes:
a contents reader reading the first digital contents from recording media in which the first digital contents are recorded;
a contents player playing the first digital contents read by the contents reader;
a contents regenerator regenerating the second digital contents by converting the first digital contents played by the contents player into a predetermined data format; and
a controller controlling the contents regenerator so that the second digital contents are encrypted by the user of the first encryption key at the time when the contents regenerator generates the second digital contents.

12. The home network system according to claim 11, wherein the contents player includes:
a graphic adapter for playing video contents among the first digital contents;
a sound card for playing audio contents among the first digital contents; and
a multimedia codec for reproducing the first digital contents into an analog signal by decoding the first digital contents in conjunction with the graphic adapter and the sound card.

13. The electronic device according to claim 9, wherein, at the time of generating the second digital contents, the controller controls the multimedia codec so as to convert the analog signal reproduced by the contents player into a digital signal and controls the contents regenerator to generate the second digital contents by compressing the digital signal in the predetermined data format, the digital signal being compressed with being encrypted by the encryption key.

14. A method for protecting unauthorized distribution of digital contents, comprising:
generating a first encryption key;
playing first digital contents; and
generating second digital contents by converting the played first digital contents into a predetermined data format, the second digital contents being encrypted by the use of the first encryption key.

15. The method for protecting the unauthorized distribution of the digital contents according to claim 14, wherein the step of generating the first encryption key includes:
preparing an RFID tag in which the first encryption key is stored in a first electronic device in which the first digital contents are played; and
extracting the first encryption key by reading the RFID tag.

16. The method for protecting the unauthorized distribution of the digital contents according to claim 15, wherein the step of playing the first digital contents includes reproducing the digital contents in an analog signal by decoding the first digital contents, and
wherein the step of generating the second digital contents includes:
converting the analog signal into a digital signal and
generating the second digital contents by compressing the digital signal in the predetermined data format, the digital signal being compressed with being encrypted by the first encryption key.

17. The method for protecting the unauthorized distribution of the digital contents according to claim 11, further comprising the steps of:
registering the first encryption key and a second encryption key assigned to a second electronic device in a home network server;
transmitting information about the second digital contents and the second encryption key from the second electronic device to the home network server at the time when the second electronic device reproduces the second digital contents;
authorizing the second electronic device by the user of the second encryption key transmitted from the second electronic device by the home network server;
transmitting the first encryption key from the home network server to the second electronic device on the basis of the information about the second digital contents, which is transmitted from the second electronic device in case that the authorization is completed by the second encryption key transmitted from the second electronic device; and
playing the encrypted second digital contents by the use of the first encryption key transmitted from the home network server by the second electronic device.

18. The method for protecting the unauthorized distribution of the digital contents according to claim 12, further comprising the steps of:
registering the first encryption key and a second encryption key assigned to a second electronic device in a home network server;
transmitting information about the second digital contents and the second encryption key from the second electronic device to the home network server at the time when the second electronic device reproduces the second digital contents;
authorizing the second electronic device by the user of the second encryption key transmitted from the second electronic device by the home network server;
transmitting the first encryption key from the home network server to the second electronic device on the basis of the information about the second digital contents, which is transmitted from the second electronic device in case that the authorization is completed by the second encryption key transmitted from the second electronic device; and
playing the encrypted second digital contents by the use of the first encryption key transmitted from the home network server by the second electronic device.

19. The method for protecting the unauthorized distribution of the digital contents according to claim 13, further comprising the steps of:
registering the first encryption key and a second encryption key assigned to a second electronic device in a home network server;
transmitting information about the second digital contents and the second encryption key from the second electronic device to the home network server at the time when the second electronic device reproduces the second digital contents;
authorizing the second electronic device by the user of the second encryption key transmitted from the second electronic device by the home network server;
transmitting the first encryption key from the home network server to the second electronic device on the basis of the information about the second digital contents, which is transmitted from the second electronic device in case that the authorization is completed by the second encryption key transmitted from the second electronic device; and
playing the encrypted second digital contents by the use of the first encryption key transmitted from the home network server by the second electronic device.
